(19) United States
(12) Patent Application Publication
(10) Pub. No.: US 2024/0367704 A1
(43) Pub. Date: Nov. 7, 2024

(54) CASTOR WITH PRESSURE BRAKE DEVICE

(71) Applicant: Elmatek International Corp., San Jose, CA (US)

(72) Inventor: Steven PO-CHENG TUNG, San Jose, CA (US)

(21) Appl. No.: 18/142,941

(22) Filed: May 3, 2023

(51) Int. Cl. B62B 5/04

(52) U.S. Cl. CPC B62B 5/0409

(57) ABSTRACT

A castor with pressure brake device includes a wheel stand; a connecting rod for connecting the wheel stand to a seat base; a wheel shaft; and two wheels. A C-shaped shaft hole is disposed on the wheel stand, and the wheel shaft is longitudinal movably fixed in the C-shaped shaft hole. A groove is disposed above the inner side of the C-shaped shaft hole; a spring is disposed in the groove and arranged vertically to the wheel shaft, wherein an end of the spring is in contact with a bottom of the groove, and the other end of the spring is in contact with the wheel shaft. Each of the wheels comprises a fitting portion, and the fitting portion is tightly sleeved on corresponding one of the two ends of the wheel shaft.

### BACKGROUND OF THE INVENTION

### Field of the Invention

The invention relates to a caster wheel of a seat, and more particularly to a castor with pressure brake device for automatic braking.

### The Prior Arts

In order to facilitate the movement of the seat, it is very common to install caster wheels under the base of seats: although the seat with caster wheels is convenient to use, the person on the seat can move without leaving the seat, but there are also risks; when leaving the seat and retaking the seat, the seat equipped with caster wheels is likely to move away from the intended sitting position due to human inattention or environmental factors, resulting in risks of an empty fall.

At present, the known part of the caster wheels used on the seat has been added with an automatic braking function; that is, when no one sits on the seat, the caster wheels are in a static braking state. The pressure exerted by the weight of human body on the caster wheel releases the brake and makes the wheel enter the rolling state when a person sits on the seat base: however, compared with ordinary caster wheels, caster wheels with automatic braking function are more complicated in structure and cost more.

### SUMMARY OF THE INVENTION

In view of this, the main purpose of the invention is to provide an castor with pressure brake device which comprises a wheel stand; a connecting rod for connecting the wheel stand to a seat base; a wheel shaft, comprising two ends, rotatably fixed on the wheel stand; and two wheels respectively fixed on the wheel shaft at the two ends of the wheel shaft.

A C-shaped shaft hole is disposed on the wheel stand, and the wheel shaft is longitudinal movably fixed in the C-shaped shaft hole.

A groove is disposed above the inner side of the C-shaped shaft hole; a spring is disposed in the groove and arranged vertically to the wheel shaft, wherein a first end of the spring is in contact with a bottom of the groove, and a second end of the spring is in contact with the wheel shaft.

Each of the wheels comprises a fitting portion, and the fitting portion is tightly sleeved on corresponding one of the two ends of the wheel shaft.

The wheel stand comprises a bottom surface, and a brake shoe is disposed on the bottom surface; the brake shoe comprises two braking portions. Each of the braking portions comprises a top surface in close contact with the outer surface of the fitting portion of a corresponding one of the wheels when the wheels are in a braking state.

In a preferred implementation, each of the fitting portions is cylindrical, and each of the braking portions is arc-shaped to match each corresponding one of the fitting portions.

In a preferred implementation, the upper surface of each braking portions is provided with an anti-slip pad.

In a preferred implementation, the brake shoe is fastened on the wheel stand through two self-tapping screws which are correspondingly disposed.

In a preferred implementation, a metal gasket is provided between the connecting rod and the wheel stand.

During application, the castor with pressure brake device is installed on a seat, and when no one is sitting on the seat, the spring touch the wheel shaft with its own elasticity, the wheel shaft and the fitting portions on the wheels move downward in conjunction to make the outer surfaces of the fitting portions in close contact with the upper surfaces of the braking portions. Through the frictions between the contact surfaces, the wheels are in a static braking state. When the user sits down on the seat, the weight of the user makes the wheel shaft and the fitting portions on the wheels move upwards in conjunction. At this moment, the wheel shaft moves upwards to pressure the spring and makes it shrinks, and the upper surfaces of the braking portions are no longer in close contact with the outer surfaces of the fitting portions. Accordingly, the brake is released, and the wheels are in a rollable state.

Other objectives, features and advantages of the present invention will be further understood from the further technological features disclosed by the embodiments of the present invention wherein there are shown and described preferred embodiments of the invention, simply by way of illustration of modes best suited to carry out the invention.

### BRIEF DESCRIPTION OF THE DRAWINGS

The invention will become more readily apparent to those ordinarily skilled in the art after reviewing the following detailed description and accompanying drawings, in which:

FIG. 1 is a schematic diagram of a castor with pressure brake device of the invention.

FIG. 2 is an exploded schematic diagram of the structure of the castor with pressure brake device of the invention.

FIG. 3 is a top view of the castor with pressure brake device of the invention.

FIG. 4 is a cross-sectional view of the castor with pressure brake device of the invention in the direction of A-A when it is in the braking state in FIG. 3.

FIG. 5 is a cross-sectional view in the direction of B-B when the castor with pressure brake device of the invention is in the braking state in FIG. 3.

FIG. 6 is a cross-sectional view in the direction of A-A when the castor with pressure brake device of the invention in FIG. 3 is in a rollable state.

FIG. 7 is a cross-sectional view in the B-B direction of the castor with pressure brake device in FIG. 3 when it is in a rollable state.

### DETAILED DESCRIPTION OF PREFERRED EMBODIMENTS

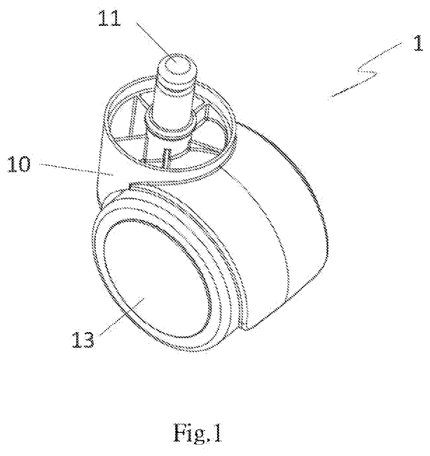

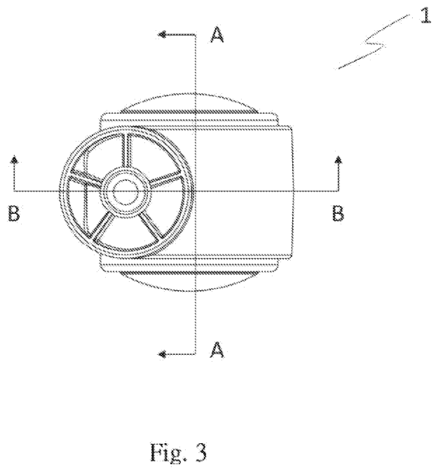

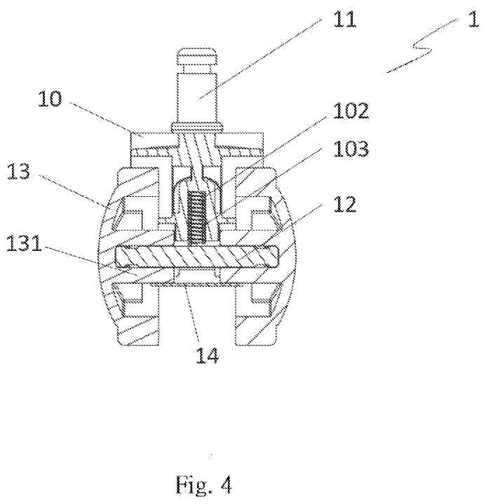

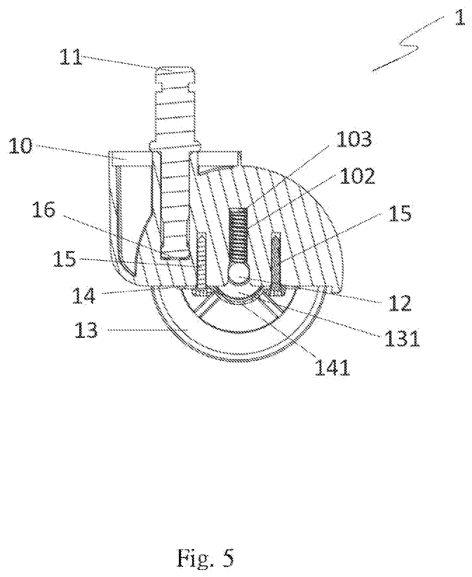

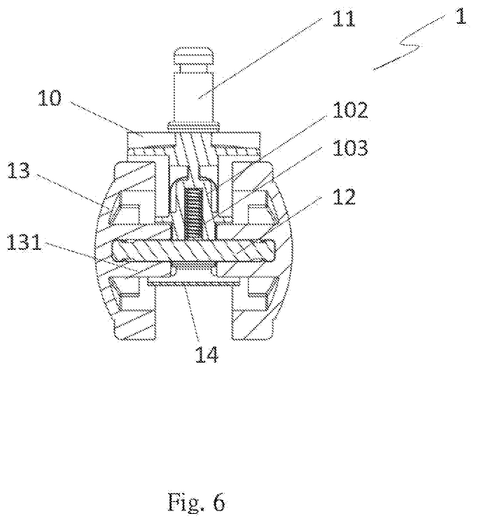

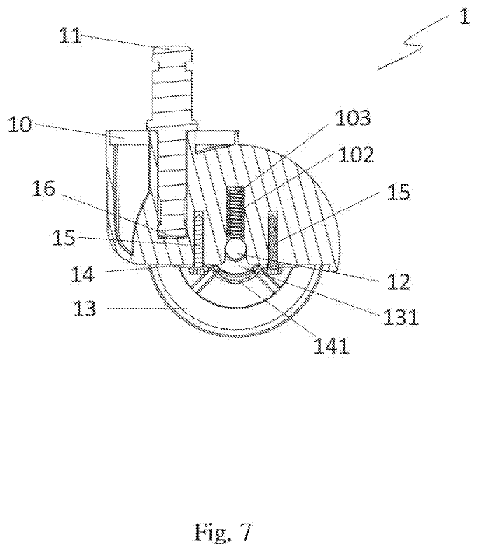

For the convenience of understanding the content of the invention, and the effect that can be achieved, the specific embodiments are listed in conjunction with the drawings, and the details are as follows. Please refer to FIG. 1 to FIG. 7, in an embodiment of the invention, the castor 1 mainly comprises: a wheel stand 10, a connecting rod 11 for connecting the seat base (not shown) and the wheel stand 10, a wheel shaft 12 rotatably fixed on the wheel stand 10, and two wheels 13 respectively fixed on two ends of the wheel shaft 12.

The wheel stand 10 is provided with a C-shaped shaft hole 101, and the wheel shaft 12 can be longitudinal movably fixed in the C-shaped shaft hole 101.

A groove 102 is provided above the inner side of the C-shaped shaft hole 101. A spring 103 is provided in the groove 102, and the spring 103 is vertically arranged with the wheel shaft 12. One end (the first end) of the spring 103 is in contact with the bottom of the groove 102, and the other end (the second end) is in contact with the wheel shaft 12.

Each of the wheels 13 is provided with a fitting portion 131, and the fitting portion 131 is tightly sleeved on a corresponding end of the wheel shaft 12.

The bottom surface of the wheel stand 10 is provided with a brake shoe 14. The brake shoe 14 comprises two braking portions 141 disposed correspondingly to each other. The upper surface of each braking portion 141 is in close contact with the outer surface of each corresponding fitting portion 131 when each corresponding wheel 13 is in a braking state.

During actual application, the automatic braking pressure wheels 1 of the invention are installed on a seat (not shown). When no one is sitting on the seat, the spring 103 in the groove 102 of the C-shaped shaft hole 101 is outwardly pushing against the wheel shaft 12 through its own elasticity. At this moment, the outer surfaces of the fitting portions 131 of the wheels 13 are in close contact with the upper surfaces of the braking portions 141 of the brake shoe 14, and the friction forces generated between the contacted surfaces make the wheels 13 in a static braking state. When a person sits on the seat, the wheel stand 10 is forced downward, and the wheels 13 stick to the ground so that the wheel shaft 12 is pushed upward and the spring 103 is retracted. At this moment, the fitting portions 131 of the wheels 13 in close contact with the upper surfaces of the braking portion 141 are separated to each other, so that the wheel 13 is in a rollable state. Through a simple structure, the wheels 13 of the seat are in a static state when the wheel 13 is stopped while no one sits on the seat. The chair will not slip due to accidental contact with the seat, and thus avoid people form sit with the chair is in an unexpected location, which makes a safer utilization of the seat.

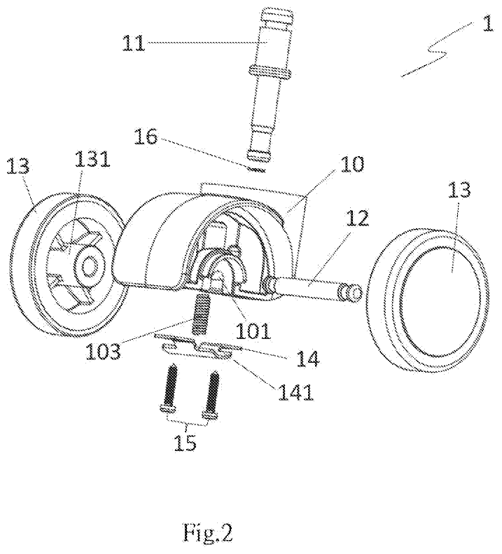

In a preferred embodiment as shown in FIG. 2 to FIG. 7, each of the fitting portions 131 is cylindrical. Each of the braking portions 141 is arc-shaped and matched with corresponding one of the fitting portions 131. The cooperation of the cylinder and the arc-shape increases the area of frictional contact and makes the braking state more stable.

In a preferred embodiment as shown in FIGS. 2 to 7, the upper surface of each of the braking portions 141 is provided with an anti-slip pad. The added anti-slip pad can improve the friction force when the braking portion 141 is in contact with the fitting portion 131, so that the braking state is more stable.

In a preferred embodiment as shown in FIGS. 2 to 7, the brake shoe 14 is fastened on the wheel stand 10 through two correspondingly provided self-tapping screws 15. Fixing the brake shoe 14 through the self-tapping screws 15 makes it more fastened and not easy to loosen.

In a preferred embodiment as shown in FIGS. 2 to 7, a metal gasket 16 is provided between the connecting rod 11 and the wheel stand 10. The additional metal gasket 16 structure provides a buffer for the friction between the connecting rod 11 and the wheel stand 10, and has a longer service life and is more durable.

Compared with the existing known technology, the caster 1 of the invention is more streamlined in structure, and the elasticity of the spring 103 can push against the wheel shaft 12 when no one is sitting on the seat, so that the braking portions 141 and the corresponding fitting portions 131 are in close contact with each other, and thus the wheels 13 are in a brake state. Accordingly, the danger of failure in sitting caused by sliding seat when people want to sit is avoided. When the user sits down on the seat, the weight of the user makes the spring 103 shrinks, and the wheels are in a rollable state, so that facilitate the user to move freely with the chair.

In summary, the novelty and practicality of the invention fully meets the requirements of a patent, and an application for a new patent is proposed. However, the above is only a preferred embodiment of the invention and should not limit the scope of implementation of the invention. Therefore, all equivalent changes and modifications made in accordance with the patent scope of the invention and the content of the invention manual should be within the scope covered by the invention patent.

What is claimed is:

1. A castor with pressure brake device, comprising:
a wheel stand;
a connecting rod for connecting said wheel stand to a seat base;
a wheel shaft, comprising two ends, rotatably fixed on said wheel stand; and
two wheels respectively fixed on said wheel shaft at said two ends of said wheel shaft;
wherein,
a C-shaped shaft hole, comprising an inner side, is disposed on said wheel stand, and said wheel shaft is longitudinal movably fixed in said C-shaped shaft hole;
a groove is disposed above said inner side of said C-shaped shaft hole; a spring, comprising a first end and a second end, is disposed in said groove and arranged vertically to said wheel shaft, wherein said first end of said spring is in contact with a bottom of said groove, and said second end of said spring is in contact with said wheel shaft;
each of said wheels comprises a fitting portion, and said fitting portion is tightly sleeved on corresponding one of said two ends of said wheel shaft;
said wheel stand comprises a bottom surface, and a brake shoe is disposed on said bottom surface; said brake shoe comprises two braking portions; and
each of said braking portions comprises a top surface in close contact with an outer surface of said fitting portion of a corresponding one of said wheels when said wheels are in a braking state.

2. The castor with pressure brake device according to claim 1, wherein each of said fitting portions is cylindrical, and each of said braking portions is arc-shaped to match each corresponding one of said fitting portions.

3. The castor with pressure brake device according to claim 2, wherein each of said upper surfaces of said braking portions is disposed with an anti-slip pad.

4. The castor with pressure brake device according to claim 3, wherein said brake shoe is fastened on said wheel stand through two self-tapping screws which are correspondingly disposed.

5. The castor with pressure brake device according to claim 4, wherein a metal gasket is disposed between said connecting rod and said wheel stand.
